(19) United States
(12) Patent Application Publication
(10) Pub. No.: US 2011/0096368 A1
(43) Pub. Date: Apr. 28, 2011

(54) Security system for printed material

(76) Inventors: James Maher, Tampa, FL (US); James Walling, Dunedin, FL (US); Timothy Armstrong, Riverview, FL (US); Sean Maher, Raleigh, NC (US)

(21) Appl. No.: 12/807,907

(22) Filed: Sep. 16, 2010

Related U.S. Application Data
(60) Provisional application No. 61/276,790, filed on Sep. 16, 2009.
(60) Provisional application No. 61/278,667, filed on Oct. 9, 2009.

(51) Int. Cl. G06K 15/02

(52) U.S. Cl. 358/3.28

(57) ABSTRACT

An improved security system is disclosed for material printed on a substrate comprising a primary marking printed on the substrate for conveying information. A secondary marking provides security to the primary marking. The secondary marking may include a variation in optical properties, a variation in magnetic properties or a variation in both in optical properties and magnetic properties of the primary marking. A method is disclosed comprising printing a primary and a secondary marking on a substrate with the primary marking conveying information and with the secondary marking providing security to the primary marking.

### CROSS-REFERENCE TO RELATED APPLICATIONS

This application claims benefit of U.S. Patent Provisional application No. 61/276,790 filed Sep. 16, 2009 and U.S. Patent Provisional application No. 61/278,667 filed Oct. 9, 2009. All subject matter set forth in provisional application No. 61/276,790 and provisional application No. 61/278,667 are hereby incorporated by reference into the present application as if fully set forth herein.

### BACKGROUND OF THE INVENTION

1. Field of the Invention

This invention relates to security and more particularly to an improved security system for print material and method such as printed documents and the like.

2. Description of the Related Art

Until the advent and commercial availability of the modern copy machine in the 1950's, copying a document was difficult if not substantially impossible. Therefore, copy protection schemes and systems were not required. The modern copy machine enabled high quality black & white copies of documents to be easily produced. As copier technology further improved and color copiers were developed, the range of documents which could be copied vastly increased even to include currency and checks.

There then became the need to produce schemes, systems and equipment to prevent unauthorized copying of documents. Paper type, quality and printing method became one attempt to prevent counterfeiting these documents. Paper containing fluorescent fibers and chemical stains and watermarks, and specialty inks such as thermo-chromic inks were used.

The printing process itself was used in an attempt to thwart counterfeiting. Security inks, various taggants, intaglio printing were utilized. Likewise, printing interference patterns, microprinting and bar codes were also employed. Post-printing techniques include bio-metrics and radio frequency identification devices.

Concurrent with copy machine development, various computer systems and devices such as I/O devices enabled a person to create an electronic copy of a document. The ability to produce an electronic copy opened new opportunities for counterfeiters when combined with high level printing devices. New opportunities were also opened for legitimate handlers of these types of documents. The need for a system to identify a document led to the development of several magnetic ink character recognition (MCIR) systems. These systems comprise fonts used on bank checks.

Two such systems are the MICR E-13B and the CMC-7. Both systems were developed in accordance with ISO (International Standards Organization) specifications. The E-13B font further complies with strict ABA and ANSI standards. The E-13B font is used for magnetic and optical character recognition in the US, Canada, the UK and several other countries. The CMC-7 system is an MICR barcode font used in Mexico, France Spain and most Spanish speaking countries.

Although these systems have provided a degree of copy protection in addition to recognition of a document, there is still a significant need to provide a more secure system to prevent unauthorized reproduction. There have been many in the prior art who have attempted to solve these problems with varying degrees of success. None, however completely satisfies the requirements for a complete solution to the aforestated problem. The following U.S. patents are attempts of the prior art to solve this problem.

U.S. Pat. No. 3,938,089 to McGregor, et al. discloses an improved character reading system that utilizes two separate read devices. A first read device and a second read device are provided in combination with a random access memory for storing each character read by the first read device, and a memory control circuit for writing each character into the random access memory. A comparison logic circuit is provided for comparing each character as read by the second read device with the corresponding character stored in the random access memory. The system also includes a time-out counter for indicating when the last character has been read and a comparison logic timing circuit for controlling the comparison logic and triggering the random access memory read control circuit so as to provide the corresponding character to the comparison logic.

U.S. Pat. No. 3,949,363 to Holm discloses a redundant character recognition system which minimizes both read failures and ambiguities caused by conflicting read signals by merging character recognition signals from MICR, OCR and Bar-Code read heads to produce a single data stream for automatic sorting of a constant velocity train of documents. In the event the MICR and OCR readers are unable to identify a character image, a Bar-Code reader is used to supplement MICR/OCR data by replacing MICR data field rejects with bar-code data field recognition signals. When rejects are generated from both the MICR and bar-code data fields, only self-checking fields within the bar-code data field are merged upon a successful self-check test being performed. If self-checking errors occur, the MICR read data is restored.

U.S. Pat. No. 4,168,088 to Somlyody discloses a document which is made secure from illegal copying by color copiers. The invention comprises including in the printed document a warning word of phrase which is made up of picture elements which are less dense than its surrounding background, but the density changes gradually and not sharply with respect to the surrounding background density.

U.S. Pat. No. 4,315,246 to Milford discloses a character recognition system for selectively reading and identifying a plurality of characters printed in magnetic ink on a first document and a second document. The documents are bank checks and the like. The system used with reader/sorter equipment for delivering data to an on-line computer. The system is characterized by the ability to store all of the character codes of the magnetic ink characters on the documents, compare the character codes and logically edit the codes. The result of the system provides the reader/sorter equipment with a superior performance due to fewer rejects and misread characters.

U.S. Pat. No. 4,351,547 To Brooks, II discloses an improved copy-proof document having a cancellation phrase with an alternating dot pattern which enhances both the detail rendition and protection of such documents. The method of making such a document by preprinting the cancellation phrase in a single tone pattern of alternating dot sizes is also disclosed.

U.S. Pat. No. 4,420,175 To Mowry, Jr. discloses a color-copier resistant document which includes a repeated invalidating phrase printed on a document, together with a background tone. In addition to having an overlay camouflage tone printed over the entire surface of the document, each of the invalidating images is formed of irregular, smooth-shaped letters which further advance their hiding characteristics. Overall sizes are suggested for the use of the invalidating word VOID, and stroke sizes for each of the letters are also disclosed.

U.S. Pat. No. 4,797,938 to Will discloses a method of improving the accuracy of identifying or reading magnetic ink characters (MICR) of the type used on checks and other documents, by choosing key values of a waveform selected using one of several templates which best fits recognized peaks. The steps of the improved method include periodically sampling the signal generated from a magnetic read head, digitizing each sample, locating peaks (in an absolute-value sense), comparing the pattern of peaks against templates (stored values preferably in the form of a saw-tooth) representative of various periods and offsets between positive and negative peaks to determine which template fits the sensed peaks best, then using that template to select samples for identification of the character. The samples thus selected are preferably in the location of the peaks and zero-crossings predicted by the best template or pattern, but are not necessarily the peaks of zero-crossings themselves. If the character is not recognized, it may be identified as a reject, or alternatively, another template (such as the next best template) may be used. Advantageously, means for differentiating an ink spot from a character are also included in the system as is a system which normalizes the character over all the peaks and not just the initial perceived peak of the character.

U.S. Pat. No. 5,271,645 to Wicker discloses commercially available pigments mixed with fluorescence compound to obtain print stuff mixtures for transfer thereafter to mattes. The print stuff mixtures obtainable thereby are used to print security and face-value documents which will be color copier resistant, that is, not be accurately reproducible or replicable by a photocopier. An empirical test is provided which will allow the ordinary skilled printer to determine the best titer of commercially available fluorescence to be used in the ink/pigment mixing scheme.

U.S. Pat. No. 5,340,159 to Mowry, Jr. discloses an improved security document according to the present invention including a substrate having a surface for carrying indicia. The document has background printed matter, consisting of a pattern of elements of a first size and frequency, printed at a first density on the surface. The document further has a cancellation term, consisting of a pattern of elements of a second size and frequency, printed at a second density on the surface. Elements of one of the first size or the second size are sufficiently small such that they are not reproduced by a color copier at a particular copier setting, and elements of the other of the first size or the second size are sufficiently large such that they are reproduced by the color copier at the particular copier setting. As a result, a copy of the security document made on a color copier displays the cancellation term. At least a portion of the security document surface is divisible into a plurality of bands extending across the surface. The sizes of the elements and the density of the background printed matter and the cancellation term vary together across the bands in a direction generally normal to the bands. As an alternative, the frequencies of the elements may vary across the bands such that the density of the background printed matter and the density of the cancellation term are changed. Such a document may be printed with different colors of ink on different portions of the document, and with the bands in which a color transition occurs being printed with two colors of ink at differing screen angles.

U.S. Pat. No. 6,171,734 to Warner, et al. discloses a paper substrate is laminated with a metalized layer forming a mirrored surface. A partially transparent black diffraction grating is applied by stochastic screening to the mirrored surface. The diffraction grating forms a random pattern from selected geometric shapes. Information, such as alphanumeric indicia or graphics, is printed on the stochastic screen to thus form a reflective diffraction device which is printable in a conventional manner while inhibiting reproduction of the printed information by conventional techniques, including black and white and color photo-reproduction and facsimile machines. The partially transparent black stochastic screen forms a diffraction grating on the metalized layer so that when illuminated from the light source of either a specular or diffuse illumination-type photocopier, random interference patterns of light occur at the interface of the metalized surface and the stochastic screen. The diffracted light is not readable by a photocopier drum with the result that the indicia is not legibly reproduced. Thus, the indicia printed on the security document is protected from counterfeiting and unauthorized copying.

U.S. Pat. No. 6,243,504 to Kruppa discloses an integrated character recognition system for providing high-accuracy detection of a magnetic ink character string of a printed medium. The character recognition system includes a magnetic ink character recognition system for reading and decoding the magnetic ink character string. An optical character recognition system is also included performing the integrated character recognition system thereby overcoming many of the limitations presented by conventional technologies. A system and method for performing complete processing of a printed media having a magnetic ink character string utilizes both the optical and magnetic ink character recognition systems to perform virtually error-free character recognition of the magnetic ink character string.

U.S. Pat. No. 7,393,623 to Conroy, et al. discloses optical media having markings that are non-interfering, or substantially non-interfering with readout of data from the optical media. The optical media make use of certain formulations of color forming coatings described herein. Protective coatings used to enhance the color forming coatings are also presented. Methods for incorporating the coatings into the optical media are included. In preferred embodiments, the marking is formed in a photosensitive coating that is applied to the optical media, and then cured with a first light. A second light, having a substantially separate band of wavelengths from the first light, is used to image a marking into the coating. The coating is robust to many external influences, such as ambient environmental conditions, and physical wear.

Although the aforementioned prior art have contributed to the development of the art of diving safety devices, none of these prior art patents have solved the needs of this art.

Therefore, it is an object of the present invention to provide an improved security system for print material and method that provides fraud identification for printed characters and symbols.

Another object of this invention is to provide an improved security system for print material and method that provides copy detection and tamper detection for printed material.

Another object of this invention is to provide an improved security system for print material and method that provides an overt level of security incorporating obvious security features.

Another object of this invention is to provide an improved security system for print material and method that provides a covert level of security incorporating hidden security features.

Another object of this invention is to provide an improved security system for print material and method that provides a forensic level of security for providing evidence of copying for law enforcement.

Therefore, it is an object of the present invention to provide an improved security system for print material and method that provides fraud identification for printed characters and symbols.

Another object of this invention is to provide an improved security system for print material and method that provides copy detection and tamper detection for printed material.

Another object of this invention is to provide an improved security system for print material and method that provides an overt level of security incorporating obvious security features.

Another object of this invention is to provide an improved security system for print material and method that provides a covert level of security incorporating hidden security features.

Another object of this invention is to provide an improved security system for print material and method that provides a forensic level of security for providing evidence of copying for law enforcement.

The foregoing has outlined some of the more pertinent objects of the present invention. These objects should be construed as being merely illustrative of some of the more prominent features and applications of the invention. Many other beneficial results can be obtained by modifying the invention within the scope of the invention. Accordingly other objects in a full understanding of the invention may be had by referring to the summary of the invention, the detailed description describing the preferred embodiment in addition to the scope of the invention defined by the claims taken in conjunction with the accompanying drawings.

### SUMMARY OF THE INVENTION

The present invention is defined by the appended claims with specific embodiments being shown in the attached drawings. For the purpose of summarizing the invention, the invention an relates to an improved security system for material printed on a substrate comprising a primary marking printed on the substrate for conveying information. A secondary marking provides security to the primary marking.

In a more specific example of the invention, the substrate is a paper substrate. The primary marking is selected from the group consisting of a letter, a number and a symbol. In one embodiment, the secondary marking is embedded within the marking primary. In another embodiment, the secondary marking is printed within the primary marking and adjacent areas of the primary marking.

Preferably, the secondary marking provides a variation in optical properties, magnetic properties or variation in both in optical properties and magnetic properties of the primary marking. In one example, the substrate is a translucent substrate. The primary marking is distinguishable from the secondary marking through light transmission through the translucent substrate. The primary marking is indistinguishable from the secondary marking through light reflection from the primary and secondary markings.

In another embodiment of the invention, the invention is incorporated into an improved security system for material printed on a substrate. A primary marking is printed on the substrate for conveying information. A secondary marking having a security pattern is embedded within the primary marking for encoding identifiable security information to the primary marking.

In a more specific embodiment, the security pattern includes a magnetic polarization pattern embedded within the primary marking. In one example, the security pattern includes a magnetic density pattern embedded within the primary marking. In another example, the security pattern includes an optical density pattern embedded within the primary marking. In a further example, the security pattern includes a magnetic and optical pattern embedded within the primary marking.

The invention is also incorporated into a method of adding a security to material printed on a substrate comprising providing a substrate. A primary and a secondary marking are printed on the substrate with the primary marking conveying information and with the secondary marking providing security to the primary marking.

The invention is also incorporated into a method of printing material with a security on a substrate comprising providing a substrate. A printer is driven with a primary printer signal for generating a primary marking on the substrate for conveying information. The primary printer signal is modulated with a secondary printer signal for generating a secondary marking embedded within the primary marking for providing security to the primary marking.

The foregoing has outlined rather broadly the more pertinent and important features of the present invention in order that the detailed description that follows may be better understood so that the present contribution to the art can be more fully appreciated. Additional features of the invention will be described hereinafter which form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be made to the following detailed description taken in connection with the accompanying drawings in which:

FIG. 1 is a block diagram of the improved security system of the present invention;

FIG. 2 is a diagram illustrating a magnetic ink character recognition (MICR) device for reading magnetic ink character;

FIG. 2A is a graph of current as a function of time generated by the coil of FIG. 1;

FIG. 3 is a top view of a MICR character;

FIG. 3A is a side view of the MICR character of FIG. 2;

FIG. 3B is a graph illustrating the response in a MICR reader;

FIG. 4 is a graph illustrating a magnetic ink hysteresis curve;

FIG. 5 is a graph illustrating the optical density and magnetic strength response to ink or toner layer thickness or mass density variations;

FIG. 6 is a graph illustrating the optical reflection density and optical transmission density response to ink or toner layer thickness or mass density variations;

FIG. 7 is a graph illustrating the thickness of the ink or toner layer “Δt” being modulated with the reflection density of the minimum thickness above a threshold;

FIG. 8 is a top view illustrating reflected light from a primary and the secondary marking in a first alternative of the security system of the present invention;

FIG. 8A is a top view illustrating transmitted light through the primary and the secondary marking of the security system;

FIG. 8B is a side sectional view of FIG. 8 illustrating the ink or toner thickness;

FIG. 8C is a graph illustrating the reflection density of the marking of FIG. 8;

FIG. 8D is a graph illustrating transmission density of the marking of FIG. 8;

FIG. 9 is a top view illustrating reflected light from a primary and the secondary marking in a second alternative of the security system of the present invention;

FIG. 9A is a top view illustrating transmitted light through the primary and the secondary marking of the security system;

FIG. 9B is a side sectional view of FIG. 9 illustrating the ink or toner thickness;

FIG. 9C is a graph illustrating magnetic response from the marking of FIG. 9;

FIG. 9D is a graph illustrating reflection density of the marking of FIG. 9;

FIG. 9E is a graph illustrating transmission density of the marking of FIG. 9;

FIG. 10 is a top view illustrating reflected light from a primary and the secondary marking in a third alternative of the security system of the present invention;

FIG. 10A is a top view illustrating transmitted light through the primary and the secondary marking of the security system;

FIG. 10B is a side view illustrating magnetic density along the marking of FIG. 10.

FIG. 10C is a graph illustrating magnetic response from the marking of FIG. 10.

FIG. 10D is a graph illustrating reflection density of the marking of FIG. 10.

FIG. 10E is a graph illustrating transmission density of the marking of FIG. 10.

FIG. 11 is a top view illustrating reflected light from the primary and the secondary marking in a fourth alternative of the security system;

FIG. 11A is a top view illustrating the magnetic polarization along the marking of FIG. 11;

FIG. 11B is a side view illustrating the magnetic polarization along the marking of FIG. 11;

FIG. 11C is a graph illustrating magnetic response from the marking of FIG. 11;

FIG. 11D is a graph illustrating reflection density of the marking of FIG. 11;

FIG. 11E is a graph illustrating transmission density of the marking of FIG. 11;

FIG. 12 is a top view illustrating reflected light from a marking;

FIG. 12A is a side view illustrating a layer thickness of the marking of FIG. 12;

FIG. 12C is a graph illustrating reflection density of the marking of FIG. 12;

FIG. 13 is a top view illustrating magnetic density of a marking;

FIG. 13A is a side view illustrating the magnetic density of the marking of FIG. 13;

FIG. 13C is a graph illustrating the magnetic response from the marking of FIG. 13;

FIG. 14 is a top view illustrating magnetic polarization of a marking;

FIG. 14A is a side view illustrating the magnetic polarization of the marking of FIG. 14;

FIG. 14C is a graph illustrating the magnetic response from the marking of FIG. 14;

FIG. 15 top view of a character marking printed on a translucent substrate;

FIG. 15A is a side view of FIG. 15 illustrating the optical reflection from the character marking and the translucent substrate;

FIG. 15B is a side view of FIG. 15 illustrating the optical transmission through the character marking and the translucent substrate; and

FIG. 16 is a top view of a document incorporating the security system of the present invention.

Similar reference characters refer to similar parts throughout the several Figures of the drawings.

### DETAILED DISCUSSION

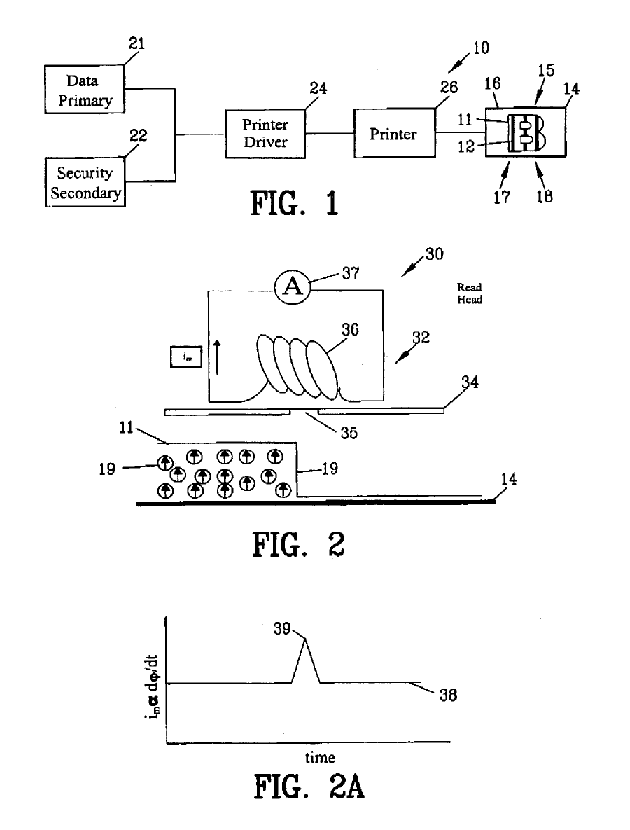

FIG. 1 is a block diagram of the method 10 of printing a primary marking 11 and a secondary marking 12 on a substrate 14 to provide the security system 15 of the present invention for a document 16 and the like. Although the present invention is described with reference to a document 16 printed on a flexible substrate 14 such as paper and the like, it should be understood by those skilled in the art that the security system 15 of the present invention may be applicable to various types of printing on various types of surfaces and the like.

A data signal containing data from an information source (not shown) provides a primary data signal 21 to a printer driver 24. A security signal provides a secondary security signal 22 to the printer driver 24. The primary data signal and secondary security signals 21 and 22 are processed by the printer driver 24 to control the output of printer 26.

The printer 26 is shown as a variable data printer capable of printing variable data on the substrate. A variable data printer 26 may be characterized as a printer capable of printing a series of unique documents in contrast to other printing methods were in all of the printed documents are identical. Preferably, the printer 26 is capable of printing variable optical markings in or variable magnetically readable markings such as a laser or an inkjet printer. Although the invention is described with reference to a laser or an inkjet printer, it should be understood that the present invention is equally applicable to lithographic, gravure, screen printing and the like.

The printer driver 24 converts the primary data signal 21 is into a data stream compatible with the printer 26. The data stream is converted by a printer controller (not shown) within the printer 26 into a map of the location of the material to be printed on the substrate 14. The primary data signal 21 results in the primary marking 11 on the substrate 14 shown as the character B.

In a similar manner, the printer driver 24 converts the secondary security signal 22 into a data stream compatible with the printer 26. The secondary security signal 22 results in the secondary marking 12 on the substrate 14 shown as security markings embedded within the primary marking 11 to enhance the security of the primary marking 11.

The primary marking 11 and the secondary marking 12 may be printed utilizing optical ink or toner 17 or magnetic ink or toner 18 or combination thereof. In the example, the secondary marking 12 are shown as lines located within the character B representative of variations in optical transmission, optical reflectively, magnetic strength, magnetic polarity or a combination of the foregoing.

As will be described in greater detail hereinafter, the secondary marking 12 may be overt, covert or forensic. In an overt security system 15, the secondary marking 12 is an obvious security features facilitating the detection of tampered or copied documents. In addition, the overt security system 15 may be used for verification and the tracking of documents.

In a covert security system, the secondary marking 12 is a hidden security feature making the printing difficult to reproduce without special knowledge of the hidden security feature. Typically, the detection of a hidden security feature of a covert security system requires special detection equipment. The present security system 15 also provides forensic evidence of tampered or copied documents for law enforcement and the like.

FIG. 2 is a diagram illustrating a magnetic ink character recognition (MICR) device 30 for reading a magnetic ink character such as the primary marking 11 in FIG. 1. The magnetic ink character recognition (MICR) device 30 comprises a reed had 32 positioned behind a magnetic shield 34 having a slot 35. A coil 36 is positioned behind the slot 35 and is connected to an ammeter 37.

The document 16 is shown having a marking 11 utilizing the magnetic ink or toner 18 defining a leading character edge 19. As the document 16 is moved past the slot 35, the coil 36 senses the leading edge 19 of the primary marking 11 and provides a current flow (iₘ) through the ammeter 37.

FIG. 2A is a graph of current (iₘ) as a function of time generated by the coil 36 of FIG. 2. As will be described in greater detail hereinafter, the magnetic response illustrated by the graph of FIG. 2A is used for identifying unique magnetic characters of the MICR convention.

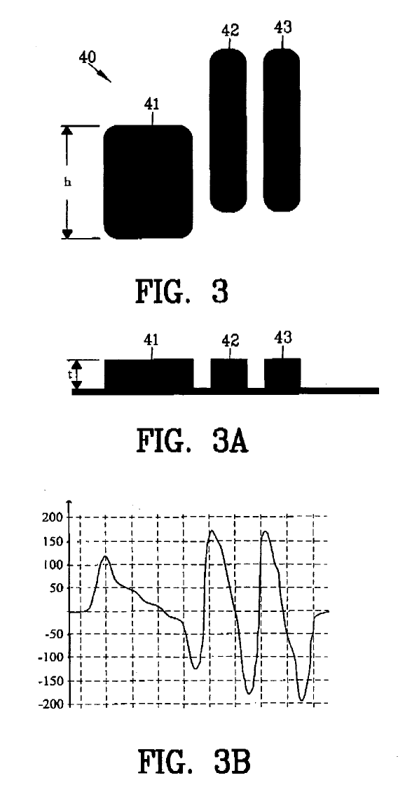

FIGS. 3 and 3A are top and side views of a MICR character 40 comprising character element 41-43. The height or length of each of the character elements 41-43 are shown in FIG. 3 whereas the thickness of each of the character elements 41-43 are shown in FIG. 3A. The thickness of each of the character elements 41-43 shown in FIG. 3A have been enlarged for explanation presentation purposes.

MICR characters are unique dimensions human readable character printed with magnetic ink. The ink is then uniformly magnetized by what is referred to as a write head. Once a MICR character is magnetized it can be read by passing a read head over the character as shown in FIG. 2. The unique magnetic response to the unique character dimensions will define the character.

FIG. 3B is a graph illustrating the response in a MICR reader of FIG. 2. The magnetic response illustrated by the graph of FIG. 3B uniquely identifies the MICR character 40. Other MICR characters are uniquely identified in a similar manner.

The signal amplitude is determined by the amount of magnetic material present including the height (h) and the thickness (t). The magnetic characteristics are derived from the use of very small magnetic particles suspended in the magnetic ink or toner 18.

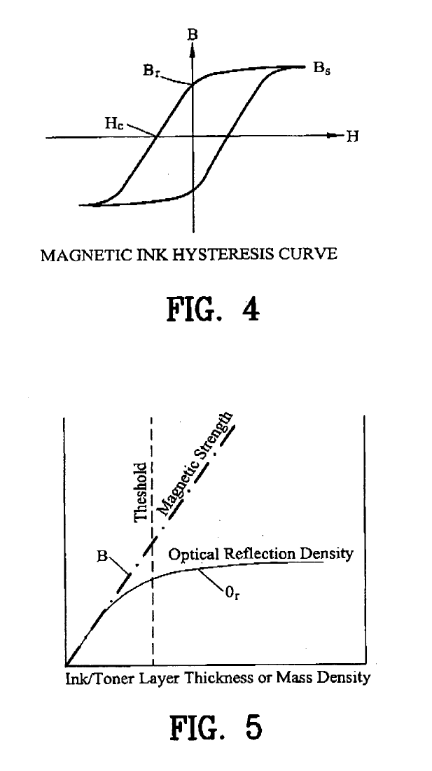

FIG. 4 is a graph illustrating a magnetic ink hysteresis curve of the magnetic ink or toner 18. The abscissa is the driving magnetic field (H) whereas the ordinate (B) is the magnetic field strength. The remanence (B_{R}) represents the strength of a permanent magnetic field after the magnetic ink or toner 18 is magnetized. The coercivity (H_{C}) represents the strength required to demagnetize the permanent magnetic field after the magnetic ink or toner 18 is magnetized.

FIG. 5 is a graph illustrating the optical density (O_{R}) and magnetic strength response (B) to ink or toner layer thickness or mass density variations of magnetic ink or toner 18. A typical dependency of reflection density on ink or toner thickness (or mass density) is presented on the same graph the dependency for the magnetic response. The magnetic strength (B) continues to increase linearly while the optical reflection density (O_{R}) saturates.

When the layer thickness is increased beyond the threshold line, the magnetic strength will change with thickness variations but the change in thickness will not be detected visually or with copying techniques due to the flattening of the curve of the optical density (O_{R}). In the event the document 16 is intentionally or accidentally demagnetized, the information that is coded into thickness changes can be recovered by simply uniformly magnetizing the document 16. This would also serve to detect tampering of the document 16.

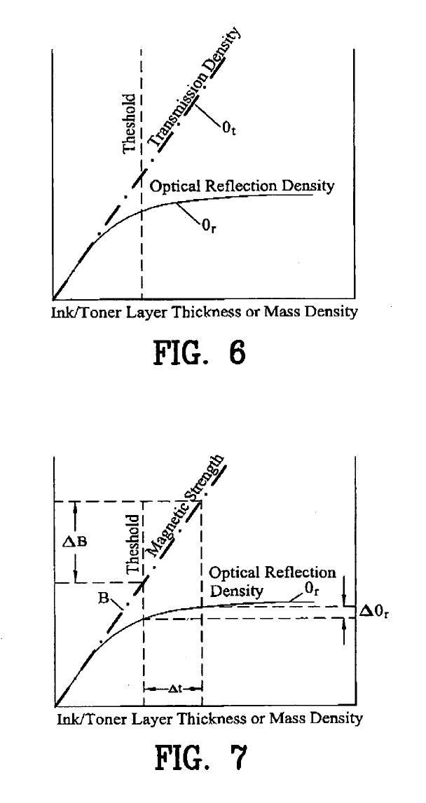

FIG. 6 is a graph illustrating the optical reflection density (O_{R}) and optical transmission density (O_{T}) response to ink or toner layer thickness or mass density variations of optical ink or toner 17. The transmission density (O_{T}) increases linearly while the optical reflection density (O_{R}) saturates. Information that is encoded into a document with thickness changes above the reflection density (O_{R}) saturation point can also be detected by measuring corresponding variations in optical transmission density (O_{T}).

FIG. 7 is a graph illustrating the reflection optical density (O_{R}) and magnetic strength response (B) to ink or toner layer thickness or mass density variations of magnetic ink or toner 18.

The thickness of the ink or toner layer “Δt” is modulated with the reflection density of the minimum thickness above the threshold of reflection optical density (O_{R}). An increase in thickness of (Δt) produces a negligible change (ΔO_{R}) in reflection optical density (O_{R}). The same increase in thickness (Δt) produces a substantial change (ΔB) in the magnetic strength response (B).

The security system 15 of the present invention adds coded optical or magnetic information to the document 16 are printed using optical ink or toner 17 or magnetic inks and toners 18. Magnetic inks and toners 18 have the characteristic of retaining a magnetic field once the magnetic inks or toners 18 are magnetized. The information is added by varying the thickness (or mass density) of the ink or toner layer, spatially, or by magnetizing the ink with a magnetic field that varies spatially, across the document 16 or both simultaneously. Preferably, the ink or toner layer thickness or mass density variations of magnetic ink or toner 18 is established to operate near or above the saturation level of the optical density (O_{R}) thereby providing the substantial change (ΔB) in the magnetic strength response (B) as shown in FIG. 7

When the thickness or mass density variations of optical inks and toners 17 s are used to encode information, the variations can be detected by measuring the point to point optical transmission density of the print.

Preferably, the ink or toner layer thickness or mass density variations of optical ink or toner 17 is established to operate near or above the saturation level of the optical density (O_{R}) thereby permitting substantial change in the optical transmission density (O_{T}) as shown in FIG. 6.

The thickness or mass density of the toner layer can be controlled, in the case of conventional photoelectrophotography, by varying the exposure level of the printer 26 (i.e. laser, LED array, etc.) printing the information on the photoconductor, or by systematically varying the development bias in response to the thickness that is required or by both in combination. In the case of e-beam or ionographic processes, the thickness can be controlled by the amount of charge laid down by the write beam in addition to the bias levels.

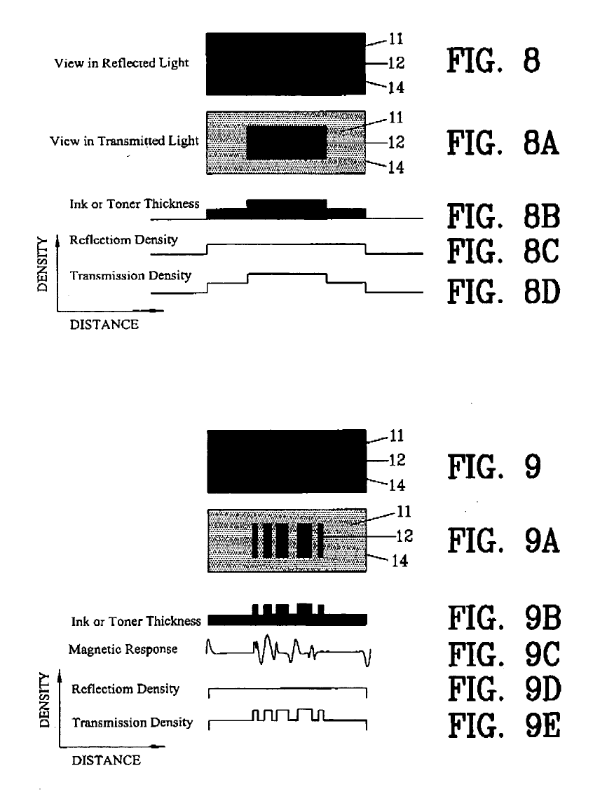

FIGS. 8-11 illustrate various alternatives for printing the primary marketing 11 and the secondary marketing 12 on a substrate 14 in accordance with the security system 15 of the present invention. The security system 15 may incorporate variations in (1) optical reflectively and transmission density patterns, (2) variations in magnetic mass density and (3) variations in magnetic domain magnetic polarity.

FIG. 8 is a top view illustrating reflected light from the primary 11 and the secondary marking 12 in a first alternative of the security system 15. The reflected light from the primary markings 11 is indistinguishable from the reflected light from the secondary marking 12.

FIG. 8A is a top view illustrating transmitted light through the primary 11 and the secondary marking 12 of the security system 15. The transmitted light through the primary markings 11 is distinguishable from the transmitted light through the secondary marking 12.

FIG. 8B is a side sectional view of FIG. 8 illustrating the ink or toner thickness.

FIG. 8C is a graph illustrating the reflection density of the marking of FIG. 8.

FIG. 8D is a graph illustrating transmission density of the marking of FIG. 8.

FIG. 9 is a top view illustrating reflected light from the primary 11 and the secondary marking 12 in a second alternative of the security system 15. The reflected light from the primary markings 11 is indistinguishable from the reflected light from the secondary marking 12.

FIG. 9A is a top view illustrating transmitted light through the primary 11 and the secondary marking 12 of the security system 15. The transmitted light through the primary markings 11 is distinguishable from the transmitted light through the secondary marking 12.

FIG. 9B is a side view of FIG. 9 illustrating the ink or toner thickness.

FIG. 9C is a graph illustrating magnetic response from the marking of FIG. 9.

FIG. 9D is a graph illustrating reflection density of the marking of FIG. 9.

FIG. 9E is a graph illustrating transmission density of the marking of FIG. 9.

FIG. 10 is a top view illustrating reflected light from the primary 11 and the secondary marking 12 in a third alternative of the security system 15. The reflected light from the primary markings 11 is indistinguishable from the reflected light from the secondary marking 12.

FIG. 10A is a top view illustrating transmitted light through the primary 11 and the secondary marking 12 of the security system 15. The transmitted light through the primary markings 11 is distinguishable from the transmitted light through the secondary marking 12.

FIG. 10B is a side view illustrating magnetic density along the marking of FIG. 10.

FIG. 10C is a graph illustrating magnetic response from the marking of FIG. 10.

FIG. 10D is a graph illustrating reflection density of the marking of FIG. 10.

FIG. 10E is a graph illustrating transmission density of the marking of FIG. 10.

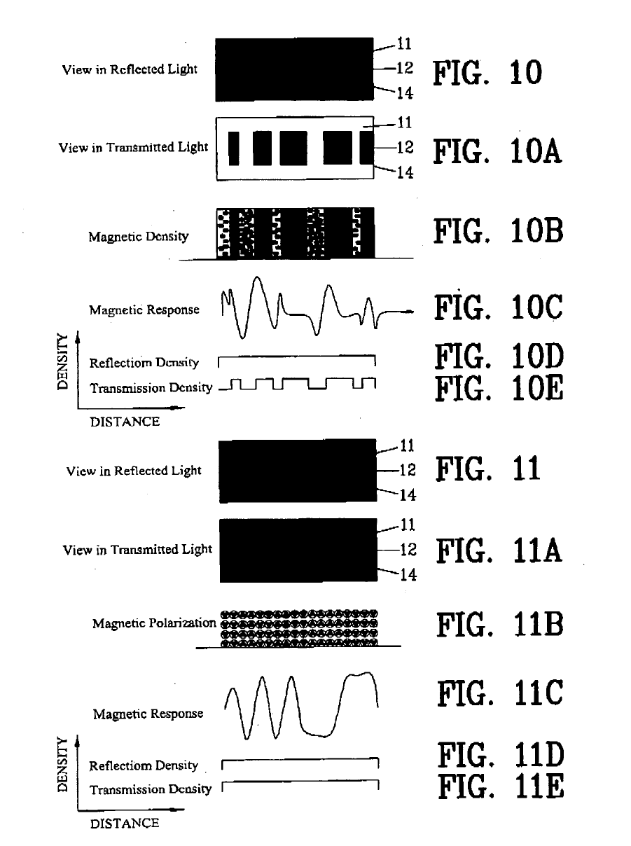

FIG. 11 is a top view illustrating reflected light from the primary 11 and the secondary marking 12 in a fourth alternative of the security system 15. The reflected light from the primary markings 11 is indistinguishable from the reflected light from the secondary marking 12.

FIG. 11A is a top view illustrating the magnetic polarization along the marking of FIG. 11.

FIG. 11B is a side view illustrating the magnetic polarization along the marking of FIG. 11.

FIG. 11C is a graph illustrating magnetic response from the marking of FIG. 11.

FIG. 11D is a graph illustrating reflection density of the marking of FIG. 11.

FIG. 11E is a graph illustrating transmission density of the marking of FIG. 11.

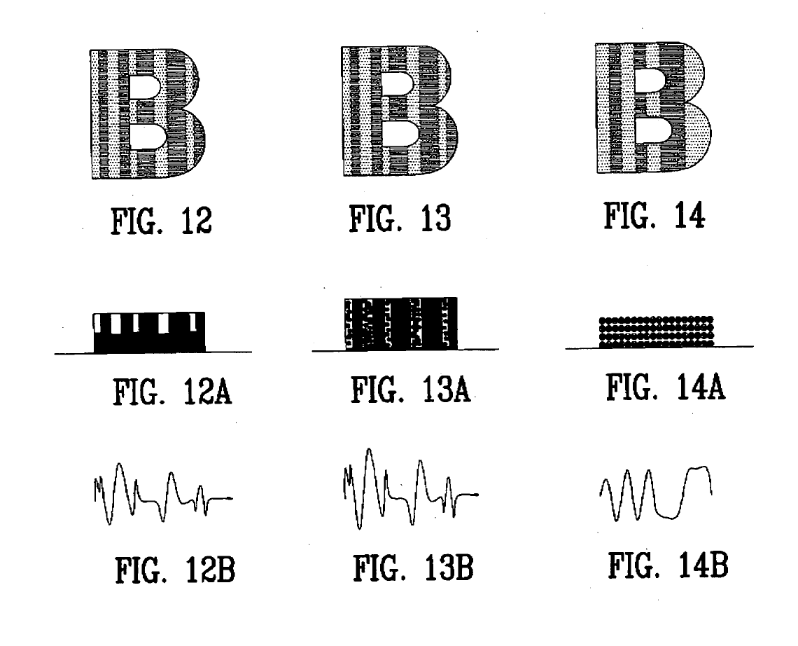

FIG. 12 is a top view illustrating the character of FIG. 1 including the primary and secondary markings 11 and 12. In this example, the character incorporates a magnetic ink or toner 18.

FIG. 12A is a side view illustrating a layer thickness of the marking of FIG. 12. The thickness of the magnetic ink or toner 18 varying across a character as shown in FIG. 12A and as shown by the shading in FIG. 12.

FIG. 12B is a graph illustrating the resulting magnetic readout after the layer of the magnetic ink or toner 18 has been magnetized.

FIG. 13 is a top view illustrating the character of FIG. 1 including the primary and secondary markings 11 and 12. In this example, the character incorporates a magnetic ink or toner 18.

FIG. 13A is a side view illustrating a variations in the mass density of the magnetic ink or toner 18 without varying the thickness of the printed layer. The variations in the mass density of the magnetic ink or toner 18 across a character is shown in FIG. 13A and is shown by the shading in FIG. 13.

FIG. 13B is a graph illustrating the resulting magnetic readout after the layer of the magnetic ink or toner 18 has been magnetized. The variations in the mass density of the magnetic ink or toner 18 produces the same effect as varying the thickness of the layer as shown in FIG. 5. The variations in the thickness and the variations in mass density of the magnetic ink or toner 18 can be achieved simultaneously on both electrophotographic and ink jet printers. In an ink jet printer, variations in the thickness and the variations in mass density can be achieved by increasing and decreasing the number and size of the ink drops deposited on the document 16.

FIG. 14 is a top view illustrating the character of FIG. 1 including the primary and secondary markings 11 and 12. In this example, the character incorporates a magnetic ink or toner 18.

FIG. 14A is a side view illustrating a layer thickness of the marking of FIG. 14. The magnetic polarization of the magnetic ink or toner 18 varying across a character as shown in FIG. 14A and as shown by the shading in FIG. 14.

FIG. 14C is a graph illustrating the magnetic response from the marking of FIG. 14. The high remanence of the magnetized magnetic ink or toner 18 results in a magnetic readout after the magnetic ink or toner 18 has been differentially magnetized.

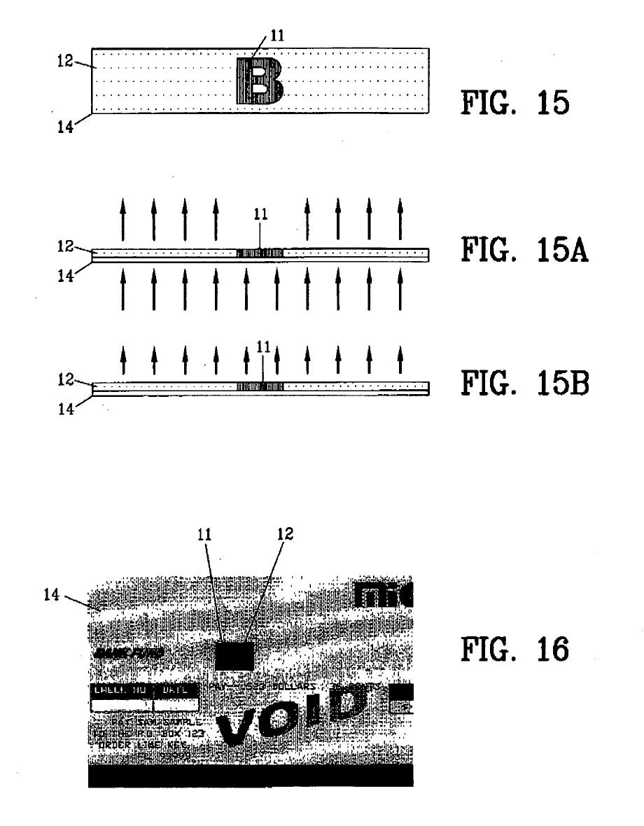

FIG. 15 is a top view illustrating transmitted light from the primary marking 11 and the secondary marking 12 in a fifth alternative of the security system 15. In this example, the secondary marketing 12 is applied to the document to overlay the primary marking 11 as well as the background of a translucent substrate 14.

FIG. 15A is a side view of FIG. 15 illustrating the optical transmission through the character marking and the translucent substrate.

FIG. 15B is a side view of FIG. 15 illustrating the optical reflection from the character marking and the translucent substrate. The reflected light from the primary markings 11 is indistinguishable from the reflected light from the secondary marking 12.

FIG. 16 is a top view of a document incorporating the security system shown in FIG. 15. The secondary marketing 12 overlays the primary marking 11 as well as a portion of the adjacent background of a translucent substrate 14.

The security system 15 of the present invention embeds information in a coded fashion to a document 16 by varying the magnetic readout of printed magnetic ink or toner by varying the thickness or mass density of the ink or toner or by varying the magnetic strength of the magnetizing field in a systematic way across the document 16. The magnetic and optical density characteristics of the document can be varied from point to point on the document either spatially, by controlling how much toner or ink or a magnetic characteristics if the toner or ink is magnetic is laid down during the printing process, or by differentially magnetizing printed areas of the document, if the toner or ink is magnetic, or both simultaneously.

The security system 15 can be enhanced by using the variable data that is used to create the document 16 as a source for the coded information. Information that must be verified, validated, or tracked can be imprinted into each document, on a document by document basis, as it is being printed. In addition, the variable data which is unique to each document can also be used to individualize the security feature. The security is coded into variations in the magnetic or optical density response of the printed toner or ink. All coded information imparted to the document printed with magnetic ink or toner will be magnetic and essentially invisible to the naked eye if the variations in ink or toner thickness or mass density are kept above the reflection density threshold.

The present disclosure includes that contained in the appended claims as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

What is claimed is:

1. An improved security system for material printed on a substrate, comprising:
a primary marking printed on the substrate for conveying information; and
a secondary marking providing security to said primary marking.

2. An improved security system for printed material as set forth in claim 1, wherein the substrate is a paper substrate.

3. An improved security system for printed material as set forth in claim 1, wherein the primary marking is selected from the group consisting of a letter, a number and a symbol.

4. An improved security system for printed material as set forth in claim 1, wherein said secondary marking is printed within said marking primary.

5. An improved security system for printed material as set forth in claim 1, wherein said secondary marking is located within said primary marking and adjacent areas of said primary marking.

6. An improved security system for printed material as set forth in claim 1, wherein said secondary marking provides a variation in optical properties of said primary marking.

7. An improved security system for printed material as set forth in claim 1, wherein said secondary marking provides a variation in magnetic properties of said primary marking.

8. An improved security system for printed material as set forth in claim 1, wherein said secondary marking provides a variation in optical properties and a variation in magnetic properties of said primary marking.

9. An improved security system for printed material as set forth in claim 1, wherein said secondary marking provides a preselected characteristic pattern within said primary marking.

10. An improved security system for printed material as set forth in claim 1, wherein said substrate is a translucent substrate; and
said primary marking being distinguishable from said secondary marking through light transmission through said translucent substrate; and
said primary marking being indistinguishable from said secondary marking through light reflection from said primary and secondary markings.

11. An improved security system for material printed on a substrate, comprising:
a primary marking printed on the substrate for conveying information; and
a secondary marking having a security pattern embedded within said primary marking for encoding identifiable security information to said primary marking.

12. An improved security system for printed material as set forth in claim 11, wherein said security pattern includes a magnetic polarization pattern embedded within said primary marking.

13. An improved security system for printed material as set forth in claim 11, wherein said security pattern includes a magnetic density pattern embedded within said primary marking.

14. An improved security system for printed material as set forth in claim 11, wherein said security pattern includes an optical density pattern embedded within said primary marking.

15. An improved security system for printed material as set forth in claim 11, wherein said security pattern includes a magnetic and optical pattern embedded within said primary marking.

16. A method of adding a security to material printed on a substrate, comprising:
providing a substrate; and
printing a primary and a secondary marking on the substrate with the primary marking conveying information and with the secondary marking providing security to the primary marking.

17. A method of adding a security as set forth in claim 16 wherein the step of printing the secondary marking comprising printing a security pattern in magnetic polarization within the primary marking.

18. A method of adding a security as set forth in claim 16 wherein the step of printing the secondary marking comprising printing a security pattern in magnetic density within the primary marking.

19. A method of adding a security as set forth in claim 16 wherein the step of printing the secondary marking comprising printing a security pattern in optical density within the primary marking.

20. A method of adding a security as set forth in claim 16 wherein the step of printing the secondary marking comprising printing a security pattern in magnetic and optical pattern within said primary marking.

21. A method of adding a security as set forth in claim 16 wherein the step of printing the secondary marking comprising printing the primary marking to have a greater optical density than the secondary marking.

22. A method of printing material with a security on a substrate, comprising:
providing a substrate;
driving a printer with a primary printer signal for generating a primary marking on the substrate for conveying information; and
modulating the primary printer signal with a secondary printer signal for generating a secondary marking embedded within the primary marking for providing security to the primary marking.

23. A method of printing material with a security on a substrate as set forth in claim 22 wherein the step of modulating the primary printer signal includes modulating the primary printer signal for printing a security pattern in magnetic polarization within the primary marking.

24. A method of printing material with a security on a substrate as set forth in claim 22 wherein the step of modulating the primary printer signal includes modulating the primary printer signal for printing a security pattern in magnetic density within the primary marking.

25. A method of printing material with a security on a substrate as set forth in claim 22 wherein the step of modulating the primary printer signal includes modulating the primary printer signal for printing a security pattern in optical density within the primary marking.

26. A method of printing material with a security on a substrate as set forth in claim 22 wherein the step of printing the secondary marking comprising printing a security pattern in magnetic and optical pattern within said primary marking.

27. A method of printing material with a security on a substrate as set forth in claim 22 wherein the step of modulating the primary printer signal includes modulating the primary printer signal for printing the primary marking to have a greater optical density than the secondary marking.
